(19) United States
(12) Patent Application Publication
(10) Pub. No.: US 2015/0283845 A1
(43) Pub. Date: Oct. 8, 2015

(54) ENCAPSULATED PRECIOUS METAL CARDS

(71) Applicant: Bullion Solutions Limited, Bromsgrove (GB)

(72) Inventor: Michael P. Marcus, Bromsgrove (GB)

(73) Assignee: Bullion Solutions Limited, Bromsgrove (GB)

(21) Appl. No.: 14/411,284

(22) PCT Filed: Jun. 24, 2013
(86) PCT No.: PCT/GB2013/051654

§ 371 Date: Dec. 24, 2014

(30) Foreign Application Priority Data
Jun. 25, 2012 (GB) 1211315.5

(51) Int. Cl. B42D 25/20; G06Q 30/00; B42D 25/305

(52) U.S. Cl. CPC B42D 25/285; B42D 25/305; G06Q 30/0185

(57) ABSTRACT

An encapsulated precious metal card (1), comprising a card (2) over which a precious metal bar (3), such as a gold or silver bar, has been encapsulated in resin (4). The card may be printed with identifying information (10, 11, 12, 13, 14, 15, 16, 18) for the precious metal, and there may be a remote-readable identifier, such as a radio frequency identification (RFID) chip (5) embedded in the card (2) also carrying identifying information.

This invention relates to encapsulated precious metal cards, where typically (but not exclusively) a gold or silver bar (or a bar of any other precious metal) has been encapsulated on a card, and to methods and collections for authenticating such encapsulated precious metal cards.

The purchase of gold, silver of other precious metals as gifts is well known in the prior art. However, the traceability of such gifts is poor; hallmarks are difficult to read and can be easily forged. As such, it is desirable to improve the traceability of precious metal bars, particularly of silver and gold, so that a buyer can be confident of the content and provenance of the bar in question.

It has been known to pack such bars in blister packs, where an enclosure having clear plastic walls is formed around the bar (see, for example, the European Patent Application published as EP 0 345 405). However, such enclosures are relatively easily tampered with, as a slit can be made in one of the walls and the true bar extracted and a replacement inserted.

According to a first aspect of the invention, there is provided an encapsulated precious metal card comprising a card over which a precious metal bar has been encapsulated in resin.

Thus, we provide a precious metal bar that has been protected against tampering by resin encapsulation. Whilst the resin, which is preferably flexible, could be picked off the card, such tampering will clearly be evident. Encapsulation therefore avoids at least some of the problems identified above with respect to the prior art.

The card may be the size of a standard credit card (that is, 3%×2% in (85.60×53.98 mm)). This is easily handled by a user.

The card may be printed with identifying information, comprising at least one of:
the weight of the bar;
the assay of the bar;
a unique identity code of the bar;
the assay office (typically identified by their logo, for example that of the Sheffield or Birmingham Assay Offices);
a confirmation that the assay office has independently assayed and weighed the bar;
identifying information of the issuing body (for example, company name and logo);
machine readable code (such as a two dimensional barcode such as a QR-code (RTM)) identifying such information as a company website and/or identifying the bar.

Thus, a purchaser of the bar can be confident that the details, including purity and weight are accurate, given that it would be evident if the card had been tampered with due to the resin encapsulation.

The card may further comprise a remotely readable identifier, such as a radio frequency identification (RFID) chip, which stores information comprising at least one of:
the weight of the bar;
the metal forming the bar;
the unique identity code of the bar;
the date that the card was purchased;
the price paid for the card;
the buyer's details.

Thus, a further confirmation of the details can be found in the RFID tag. Because this information is stored in the card, a (subsequent) purchaser of the card can be assured that the bar is legitimate, presuming that the details on the RFID tag match the details printed on the card.

The bar may carry indicia, typically stamped or engraved, denoting at least one of the following:
the weight of the bar;
the purity of the bar (typically 99.95% pure);
the unique identity code for the bar;
the identity of the issuing body (for example, company name);
the assay office.

Thus, by comparing the information from at least two sources being the information on the bar, the printed information on the card and the information stored on the remotely readable identifier, a user can satisfy themselves that there is little prospect of tampering and that the bar encapsulated on the card is authentic.

The weight of the bar could be any of:
Metric measurements:
   1 gram
   2 gram
   2.5 gram
   3 gram
   3.5 gram
   4 gram
   4.5 gram
   5 gram
   10 gram
   15 gram
   20 gram
   25 gram
   31.104 gram
   40 gram
   45 gram
   50 gram
Imperial measurements (using troy ounces)
   tenth of an ounce (3.11 grams)
   fifth of an ounce (6.22 grams)
   quarter of an ounce (7.78 grams)
   half of an ounce (15.6 grams)
   one ounce (31.1 grams)

Preferably, the precious metal bar is a gold or silver bar. Alternatively, the bar could be of any other precious metal, such as platinum, rhodium, iridium, osmium, palladium, rhenium or ruthenium. In another alternative, rather than being of a precious metal, the bar could be of copper, pewter or non ferrous metals in the form of coins, medals and bars. In addition, in place of the bar, we could provide stones, plastics, ceramics and clays.

The bar may be oblong (as is common with precious metal bars) or round (as in bullion coins and the like).

The resin, and the card, may be flexible, which may aid in the life of the product and ensuring that there are no false positives for tampering.

The card may be plastic, or formed of paper or any other suitable material.

Preferably, the card is flexible.

According to a second aspect of the invention, there is provided a method of authenticating an encapsulated precious metal card in accordance with the first aspect of the invention, in which information comprising at least one of:
a weight of the bar;
an unique identifier of the bar;
is stored in at least two locations on the bar, the locations being selected from the group formed of:
the surface of the card, typically in human-readable;
the surface of the bar;
a remotely readable identifier, such as an RFID tag or a two-dimensional bar-code such as a QR-code (RTM);
   the method comprising comparing the information between the locations to check that it is consistent.

Additionally, the information may also comprise at least one of:
the assay of the bar;
the assay office;
the metal forming the bar;
the date that the card was purchased;
the price paid for the card;
the buyer's details.
the purity of the bar
the identity of the issuing body.

Furthermore, the method may comprise checking the information for consistency against a remotely-stored database; typically the database will be operated by the issuer of the encapsulated gold bar. The information may comprise a link to the database; the link may be a web link comprising or referring to the unique identifier of the bar.

According to a third aspect of the invention, there is provided a collection comprising a plurality of encapsulated precious metal cards according to the first aspect of the invention, and an computer having storage holding a database, the database comprising an entry for each of the encapsulated precious metal cards, each entry comprising at least one of a weight of the bar and a unique identifier of the bar.

Additionally, each entry may comprise at least one of:
the assay of the bar;
the assay office;
the metal forming the bar;
the date that the card was purchased;
the price paid for the card;
the buyer's details.
the purity of the bar
the identity of the issuing body.

The computer may also comprise a network interface and a processor, the processor being arranged to act as a server to allow access to the database over a network (typically the Internet). The server may be a webserver, and the server may be responsive to a link stored on each encapsulated precious metal card to provide information, typically in the form of a webpage, contained in the entry for the relevant encapsulated precious metal card. The link may be printed on the card in human-readable form, of may be of the form of a two-dimensional bar code, such as a QR-code (RTM) or may be carried in a remotely readable identifier such as an RFID tag embedded in the card.

There now follows description of an embodiment of the present invention, described with reference to the accompanying drawings, in which:

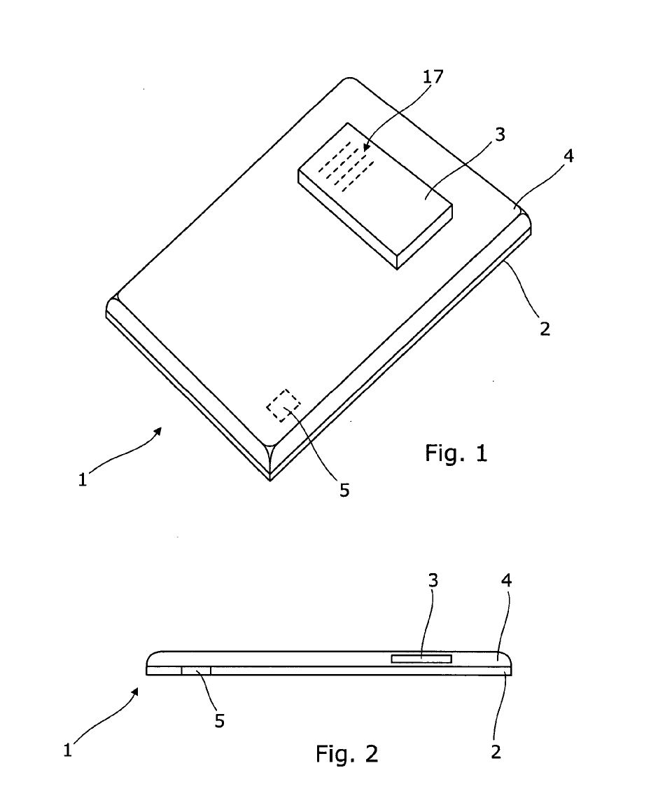

FIG. 1 shows a perspective view of an encapsulated gold card in accordance with a first embodiment of the invention;

FIG. 2 shows a cross-sectional view through the encapsulated gold card of FIG. 1;

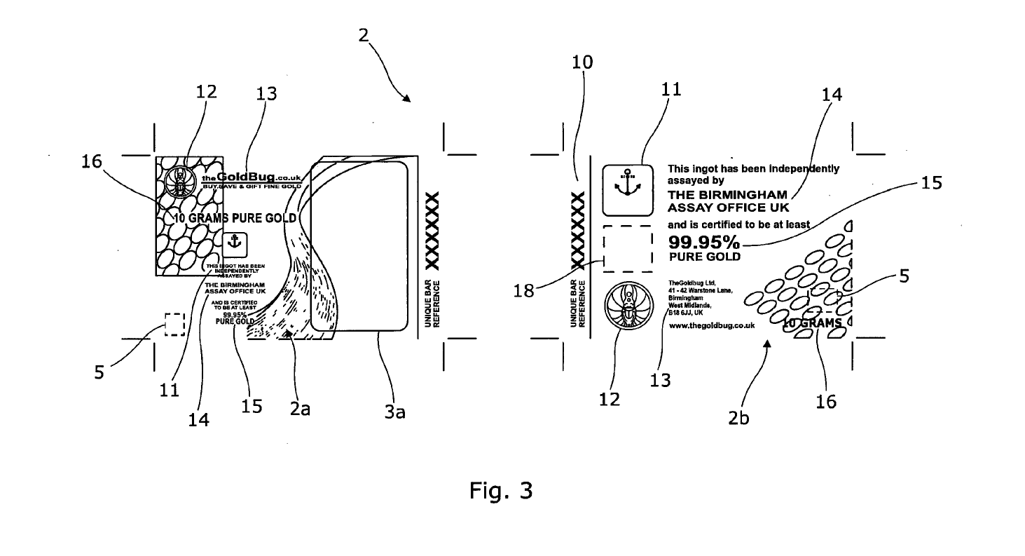

FIG. 3 shows the details carried on both sides of the card forming part of the encapsulated gold card of FIG. 1; and

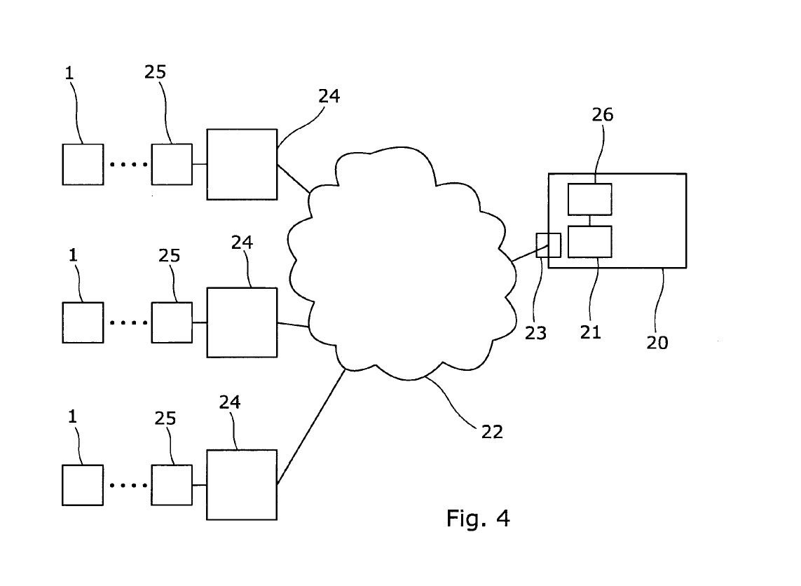

FIG. 4 shows a network in accordance with a second embodiment of the invention.

An encapsulated gold card 1 in accordance with a first embodiment of the invention is shown in the accompanying drawings. This comprises a base card 2 supporting a gold bar 3. Over the bar 3 and the base card 2 there has been applied a transparent flexible resin encapsulation 4. For example, the resin may be a flexible doming resin, such as a polyurethane resin. Embedded in the base card 2 there is a radio frequency identification (RFID) chip 5.

As such, the resin encapsulation 4 of the gold bar 3 on the base card 2 provides a buyer or potential buyer with some peace of mind, as it will be evident whether the encapsulation 4 has been tampered with, for example by being picked away.

The encapsulated gold card 1 of this embodiment also has further security features. As can be seen in FIG. 3 of the accompanying drawings, the base card 2 carries various information on both its obverse 2a and reverse 2b. The information includes:
A unique bar reference 10 for the bar 3;
The logo 11 and name 14 of the assaying office;
The logo 12 and name and other identifying details 13 of the issuer of the encapsulated gold bar 1;
The purity (or assay) 15 of the bar 3;
The weight 16 of the bar.

At least some—preferably including the unique bar reference—of this information is also stamped onto the bar 3 at position 17. Thus, a user can compare the information carried in the different locations to ensure that the bar matches its description.

The information can be printed on the card 2 in any convenient orientation, typically either portrait or landscape.

Furthermore, the information referred to above can also be stored in the RFID chip 5. This is invisible to the human eye (as it is embedded in the card), but can be read by any suitable RFID chip reader. Thus, a prospective buyer can furthermore check that the details 17 marked on the bar 3 and shown on the base card 2 match that stored in the RFID chip; if all three match, a (possibly prospective) buyer can have peace of mind that the encapsulated gold bar is genuine.

Furthermore, the card can be provided with a unique two-dimensional bar code 18, typically of the form of a QR code (RTM) (that is, a two dimensional bar code that complies with the standard SO/IEC 18004:2006). This can store the information referred to above (providing a further layer of security), or can provide a link to the website of the issuer. Typically, this link would be to a dedicated webpage for the encapsulated gold bar 1 in question; thus, the issuer's server may be provided with a database of the encapsulated gold bars 1 that it has issued, identified by their unique bar reference 10. An interested party can therefore check the details stored in the various places in the encapsulated gold card 1 against that stored in the database, in order to check the authenticity of the information and hence the encapsulated gold card 1.

The obverse 2a of the card can be provided with a location 3a for the bar 3; if the bar 3 has been moved from this location, it is possible that there has been tampering. Of course, the location 3a could be anywhere convenient on the bar, and can be in any orientation relative to the bar (not just portrait or landscape).

In an alternative, instead of the link being from the two dimensional bar code 18, it may be from the RFID chip 5; reading this may provide a link to the issuer's database referred to above.

In another alternative, the gold bar could be of any other precious metal, such as silver or any of platinum, rhodium, iridium, osmium, palladium, rhenium or ruthenium. In another alternative, rather than being of a precious metal, the bar could be of copper, pewter or non ferrous metals in the form of coins, medals and bars. In addition, in place of the bar, we could provide stones, plastics, ceramics and clays.

FIG. 4 shows the operation of a network arranged to authenticate the encapsulated gold card of the first embodiment of the invention, which operates within a second embodiment of the invention. In this embodiment, there is a server 20 (which can be of the form of any suitable processing apparatus, such as a personal computer running Microsoft (RTM) Windows (RTM) or a server running a variety of UNIX (RTM)). The server 20 has storage 21 such as a hard disk, a processor 26 and a network interface 23.

The server 20 stores in its storage 21 a database comprising an entry for each of a plurality of encapsulated gold cards 1. Each entry comprises the following information:
the weight of the bar;
a unique identifier of the bar;
the assay of the bar;
the assay office;
the metal forming the bar;
the date that the card was purchased;
the price paid for the card;
the buyer's details.
the purity of the bar
the identity of the issuing body.

As discussed above, each of the encapsulated gold cards 1 contains a link to this database. An interested part can take the encapsulated gold card 1 to a terminal 24 (of the form of a common personal computer), which is provided with a card reader 25. The reader 25 could be an RFID chip reader, where the link is stored in the RFID chip 5, or a camera, where the link is in the two-dimensional bar code 18. In this latter case, the terminal could be a user's camera-enabled smart phone. Each terminal 24 is connected to the same network 22 as the server 20, which may be the Internet.

When the server 20 receives a link, it will serve a webpage back to the terminal 24 from which the link was received. The webpage will contain the information contained in the database entry for the relevant encapsulated gold card 1. Thus, the interested party can be reasonably sure that, if the information on the card and in the database matches, that the encapsulated gold card 1 is authentic and (presuming that the resin shows no sign of tampering) matches the details shown on the encapsulated gold card 1 and in the database.

For reference, there now follows the contents of the inventor's previous application.

1. An encapsulated card comprising a card over which a body comprising a precious metal bar or stones has been completely encapsulated in resin.

2. The encapsulated card of claim 1, wherein the body is a precious metal bar being a gold or silver bar.

3. The encapsulated card of claim 1, wherein the resin is flexible.

4. The encapsulated card claim 1, wherein the card is the size of a standard credit card.

5. The encapsulated card of claim 1, wherein the card is printed with identifying information, comprising at least one of:
the weight of the body;
the assay of the body;
a unique identity code of the body;
the assay office;
a confirmation that the assay office has independently assayed the body;
identifying information of the issuing body;
machine readable code identifying at least one of a company website and the body.

6. The encapsulated of claim 1 wherein the card further comprises a remotely readable identifier which stores information comprising at least one of:
a weight of the body;
a metal forming the body;
an unique identity code of the body;
a date that the card was purchased;
a price paid for the card;
a buyer's details.

7. The encapsulated card of claim 1, wherein the body carries indicia denoting at least one of the following:
a weight of the body;
a purity of the body;
a unique identity code for the body;
a identity of an issuing body;
an assay office.

8. A method of authenticating an encapsulated card comprising a card over which a body comprising a precious metal bar or stones has been completely encapsulated in resin, in which information comprising at least one of:
a weight of the body; and
an unique identifier of the body;
is stored in at least two locations on the card, the locations being selected from the group including:
the surface of the card;
the surface of the body;
a remotely readable identifier
the method comprising comparing the information between the locations to check that it is consistent.

9. The method of claim 8, wherein the information also comprises at least one of:
an assay of the body;
an assay office;
a metal forming the body;
a date that the card was purchased;
a price paid for the card;
a buyer's details.
a purity of the bar
an identity of an issuing body.

10. The method of claim 8, further comprising checking the information for consistency against a remotely-stored database.

11. The method of claim 10, wherein the information comprises a link to the database.

12. A collection, comprising:
a plurality of encapsulated cards each comprising a base card over which a body comprising a precious metal bar or stones has been completely encapsulated in resin, and
a computer having storage holding a database, the database comprising an entry for each of the encapsulated cards, each entry comprising at least one of a weight of the bar and a unique identifier of the bar.

13. The collection of claim 12, wherein each entry comprises at least one of:
an assay of the body;
an assay office;
a metal forming the body;
a date that the card was purchased;
a price paid for the card;
a buyer's details.
a purity of the bar
an identity of an issuing body.

14. The collection of claim 12 wherein the computer comprises a network interface and a processor, the processor being arranged to act as a server to allow access to the database over a network.

15. The collection of claim 14, wherein the server is a webserver, and the server is responsive to a link stored on each encapsulated card to provide information, typically in the form of a webpage, contained in the entry for the relevant encapsulated precious metal card.
